(19) United States
(12) Patent Application Publication
(10) Pub. No.: US 2007/0195772 A1
(43) Pub. Date: Aug. 23, 2007

(54) DISTRIBUTED IGMP PROCESSING

(75) Inventor: Bryan Shadish, Pleasanton, CA (US)

Correspondence Address: John Nielsen, Suite 400, 5000 Hopyard Road, Pleasanton, CA, 94588, US

(73) Assignee: ALLOPTIC, INC., Livermore, CA (US)

(21) Appl. No.: 11/629,749

(22) PCT Filed: Jun. 14, 2004
(86) PCT No.: PCT/US04/18920

§ 371 Date: Dec. 14, 2006

(51) Int. Cl. H04L 12/56

(52) U.S. Cl. 370/390; 370/395.52

(57) ABSTRACT

The present invention implements a distributed IGMP implementation. It connects to one or more multicast data sources from one node within a collection of cooperating computing devices. Other computing devices within the collection of cooperating computing devices connect to one or more IP hosts who wish to receive the multicast data. The IGMP implementation is divided between the computing device that connects to the multicast data sources and the computing devices that connect to the consumers of that source.

### FIELD OF THE INVENTION

The present invention relates to the field of Internet Protocol (IP). Specifically, this invention relates to assigning different parts of Internet Group Management Protocol (IGMP) to different computer devices via layer 2 ports attached to a plurality of computer devices.

### BACKGROUND OF THE INVENTION

IGMP is the standard for IP multicasting in the Internet. It is used to establish host memberships in particular multicast groups on a single network. The mechanisms of the protocol allow a host to inform its local router, using host membership reports, that it wants to receive messages addressed to a specific multicast group. IGMP is a protocol that supports registration between IP-based computer terminals and IP-based routers or hosts that are directly attached to the same IP subnet. Additionally, such IP-based routers or hosts support multiple IP subnets concurrently.

The prior art implements a feature commonly known as IGMP snooping, which is classically done on a single CPU device, to quietly look at packets that are flowing through the system and discretely pick up IGMP packets of interest. IGMP snooping allows layer 2 switching devices to passively capture a copy of IGMP protocol packets and to use the information provided by those packets to selectively forward multicast data streams to one or more physical ports and subsequently to computer devices. At the same time, switching devices may forward IGMP snooping packets to one or more physical ports, in order to convey its own multicast data stream forwarding requirements on to the other routers or layer 2 switching devices on other layer 2 physical segments. As such, an IGMP packet can extend beyond its original layer 2 physical segment.

Although IGMP snooping allows the system to discretely look at packets flowing through the system; IGMP protocol is limited in that the request packets are transmitted in an unreliable fashion. In other words, the packets are transmitted in such a way that the transmitter can never be sure that the intended recipients actually receive the packets. As a result, IGMP is continuously retransmitting its packets, which increases the number of packets that flow over the network, which in turn increases the processing load on the hosts and routers that support the IGMP protocol.

FIG. 1 illustrates an example of a prior art system utilizing IGMP protocol. In this prior art system, a switching device 2, or central processing unit (CPU), contains four (4) ports for transmitting data to devices such as computer devices. In order to receive a multicast stream, a multicast stream requestor 4 sends an IGMP membership report request to the switching device via port #4. Once this request has been sent to the switching device 2, the switching device 2 then forwards the IGMP membership report request to all other ports, in this example, ports 1, 2, and 3. A multicast stream source 6, connected to the switching device 2 via port #1, receives the IGMP membership report request. As the multicast stream source 6 is only connected to one port, transmitting the request via ports 2 and 3 unnecessarily increases the processing load of the switching device 2.

FIG. 2 illustrates the response of the multicast stream source 6 of the prior art system of FIG. 1. After receiving the IGMP membership report request from the switching device 2, the multicast stream source 6 transmits the requested multicast stream to the switching device 2 to port #1. In turn, the switching device 2 forwards the multicast stream only out port #4 since this was the source of the original IGMP membership report request. As a result, the multicast stream requestor 4 receives the multicast stream.

FIG. 3 illustrates the prior art system after the switching device 2 forwards the multicast stream to the multicast stream requester 4. The multicast stream requestor periodically transmits IGMP membership report requests to ensure continuous reception of the multicast stream due to the unreliable link utilized in the IGMP protocol. Upon receiving the continued IGMP membership report requests sent periodically to the switching device 2, the switching device 2 continues to forward the IGMP membership report request to all other ports, again unnecessarily increasing the processing load of the switching device 2. The multicast stream source 6 connected to port #1 again receives the IGMP membership report request and continues to send the multicast stream to the switching device 2 and subsequently to the multicast stream requestor 4.

FIG. 4 illustrates a prior art system utilizing IGMP protocol containing a second multicast stream requestor 8. The switching device 2 continues to forward the multicast stream only out of port #4. In this prior art system, the switching device 2 is connected to the second multicast stream requestor 8 which also transmits an IGMP membership report request to the switching device, however via port #3. Once this request has been sent to the switching device 2, the switching device 2 forwards the IGMP membership report request to all other ports, in this example, ports 1, 2, and 4. A multicast stream source 6, connected to the switching device 2 via port #1, receives the IGMP membership report request and continues to transmit the multicast stream to the switching device 2. As the IGMP membership report request is sent out to port #2 in addition to port #1, this will unnecessarily increase the processing of the switching device 2.

FIG. 5 illustrates a prior art system of FIG. 4 utilizing IGMP protocol with a second multicast stream requestor 8 receiving the multicast stream. In FIG. 5, the multicast stream source 6 continues to transmit the multicast stream to the switching device 2 via port #1. However, the switching device forwards the multicast stream via port #3, since the second multicast stream requester 8 issued an IGMP membership report request multicast stream. As the multicast stream requester 4 was the first device to request an IGMP membership report request, the switching device continues to forward the multicast stream via port #4.

The prior art systems, described above with reference to FIGS. 1-5, are unsatisfactory. All requests are going through a central CPU that is a master over all the other devices at a detailed level, as such a lot of overhead is needed, which means inefficient use of the computing device and inefficient use of the bandwidth. Another limitation of the IGMP protocol is hat the request packets are transmitted in an unreliable fashion. In other words, the packets are transmitted in such a way that the transmitter can never be sure that the intended recipients actually receive the packets. As a result, IGMP is continuously retransmitting its packets as illustrated in FIGS. 1-5 above. Continuously retransmitting the packets increases the number of packets that flow over the network, which in turn increases the processing load on the hosts and routers that support the IGMP protocol. What is needed is a system that minimizes IGMP traffic, which reduces both the overall bandwidth requirements and the load on the CPU at the designated computer device.

### SUMMARY OF THE INVENTION

It is an object of the present invention to provide connections to layer 2 ports that originate multicast traffic flows.

It is a further object of the present invention to provide connections to layer 2 ports that transmit multicast traffic flow to consumers through multicast stream sources.

It is yet a further object of the present invention to minimize IGMP traffic by utilizing a reliable link.

It is yet a further object of the invention to assign separate roles to the designated computer devices and to the central processing module, whereby the designated computer device manages multicast streams for consumers and the central processing module manages interaction with the multicast stream source.

It is yet a further object of the invention to terminate all IGMP protocol packets received by the designated devices in order to isolate consumers into groups defined by common access to an individual designated device port.

It is yet a further object of the present invention to reduce both the overall bandwidth requirements and the load on the CPU at designated computer devices or at the central processing module.

It is yet a further object of the present invention that all CPUs run autonomously and are geographically dispersed.

In the present invention, IGMP traffic is minimized by utilizing a reliable link. A reliable link guarantees that when a distributed device sends a request for a multicast traffic stream, the distributed device gets the response from the central processor module. In other words, the central processor module has received the request and will start processing the request.

In an exemplary embodiment of the present invention, a central processing module is connected to four distributed devices and a multicast source. The distributed devices are connected to the central processor, via transmission lines, which transmit requests to the multicast source via the central processing module to receive multicast streams. To request a multicast stream, a multicast stream requester issues an IGMP membership report request through a distributed device. The distributed device sends the multicast stream update request to the central processor over a reliable link. The central processor module determines if any other distributed devices are requesting a multicast stream before sending the IGMP membership report request to the multicast source. If another distributed device has requested the multicast stream, the central processor module does not need to send the IGMP membership report request to the multicast source. Furthermore, if a distributed device detects a request from a different multicast stream requester, the distributed device does not forward the request to the central processor and instead sends the multicast stream it is already receiving for a first multicast stream requestor to the different multicast requestor. As a result of utilizing a reliable link, both the overall bandwidth and the processing load on the central processor module are reduced.

In addition to the sending and receiving requests for a multicast stream, the present invention also sends and receives requests for stopping the multicast stream. To accomplish this, a consumer, through a multicast stream requestor attached to a distributed device, sends an IGMP leave request for the multicast stream. When appropriate, a distributed device in turn sends a multicast stream update request to the central processor module. The central processor module receives the request and will discontinue to send the multicast stream if no other distributed device is requiring the central processor module to continue the multicast stream. If there is another distributed device that requires the multicast stream, the central processor module will continue to send the multicast stream. If a multicast stream update request for the multicast stream is sent by all of the distributed devices currently receiving the multicast stream, the multicast source may choose to continue sending the multicast stream or it may choose not to continue to send the multicast stream. If the multicast source continues to send the multicast stream, the central processor module will not forward the multicast stream to the distributed devices.

The foregoing, together with other features and advantages of the present invention, will become more apparent when referring to the specification, claims and accompanying drawings.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 illustrates a prior art system utilizing IGMP protocol;

FIG. 2 illustrates the response of the multicast stream source of the prior art system of FIG. 1;

FIG. 3 illustrates the prior art system after the switching device forwards the multicast stream to the multicast stream requester;

FIG. 4 illustrates a prior art system utilizing IGMP protocol with a second multiple multicast stream requester;

FIG. 5 illustrates a prior art system of FIG. 4 utilizing IGMP protocol with a second multiple multicast stream requester;

FIG. 6 illustrates an exemplary embodiment of the system of the present invention;

FIG. 7 illustrates a first multicast stream requestor issuing an IGMP membership report request for a multicast stream through a distributed device;

FIG. 8 illustrates the system of the present invention after the multicast source has received the IGMP membership report request;

FIG. 9 illustrates the system of the present invention with multiple multicast stream requesters;

FIG. 10a illustrates a flow diagram of a first consumer, attached to a distributed device requesting a multicast stream;

FIG. 10b illustrates a flow diagram of a second consumer attached to a distributed device requesting a multicast stream;

FIG. 10c illustrates a flow diagram of the distributed device maintaining the IGMP protocol to consumers;

FIG. 11a illustrates a flow diagram of a first consumer, attached to a distributed device, requesting to no longer receive a multicast stream;

FIG. 11b illustrates a flow diagram of a second consumer, attached to a distributed device, requesting to no longer receive the multicast stream;

FIG. 11c illustrates a flow diagram of a second consumer, attached to the distributed device, requesting to no longer receive the multicast stream, however other distributed devices still require the central processor module to continue sending the multicast stream;

FIG. 12 illustrates the system of the present invention with is multiple multicast stream requesters connected to multiple distributed devices;

FIG. 13 illustrates the advantage of the present invention in utilizing a reliable link;

FIG. 14a illustrates a flow diagram of the central processor module receiving a multicast stream update request from a distributed device that requests a multicast stream;

FIG. 14b illustrates a flow diagram of the central processor module maintaining IGMP protocol with the multicast source; and

FIG. 14c illustrates a flow diagram when the distributed device indicates multicast stream is no longer needed, and no other attached distributed devices currently require a multicast stream.

### DETAILED DESCRIPTION

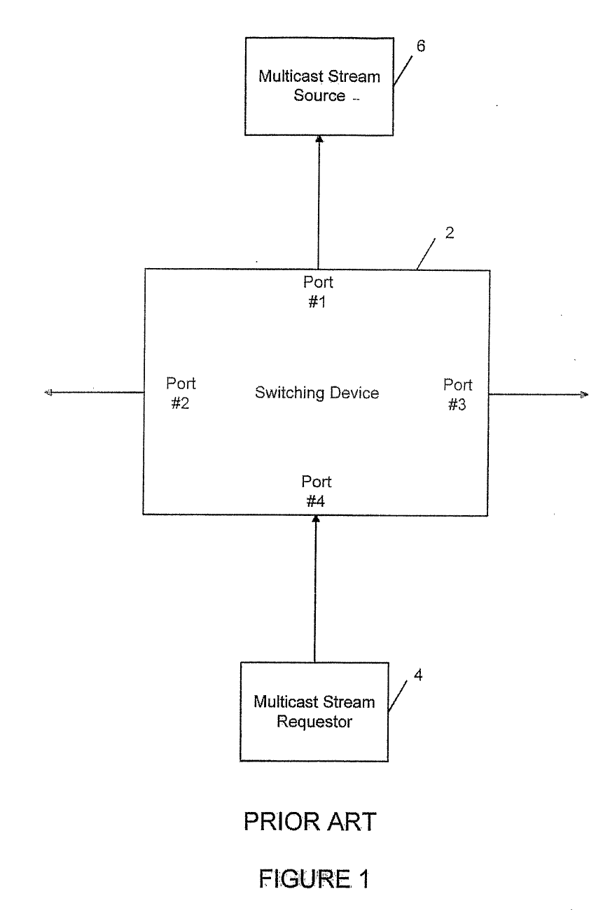

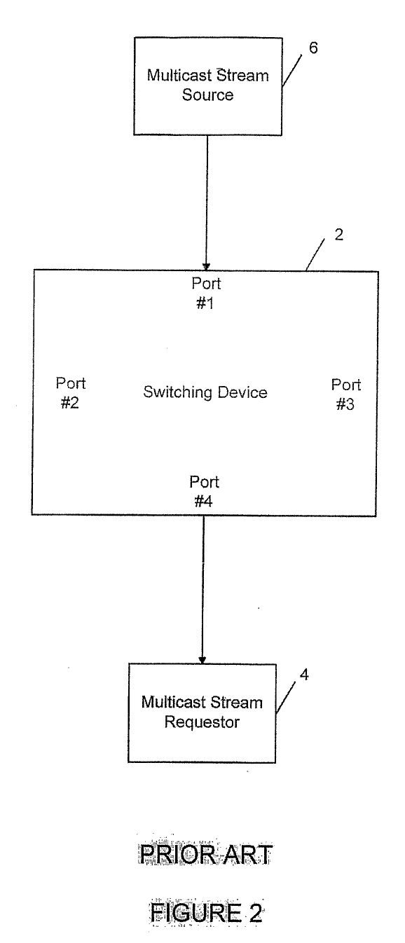

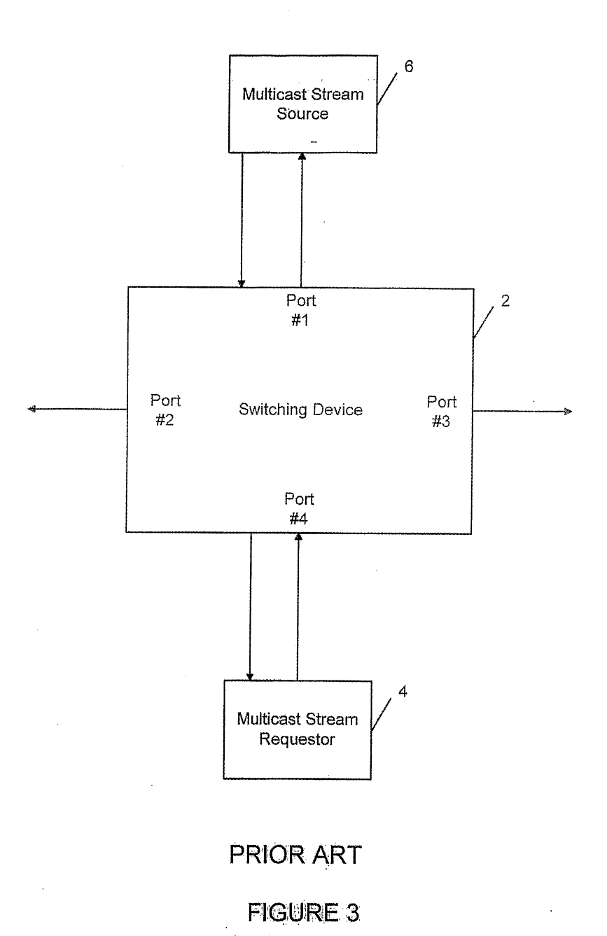

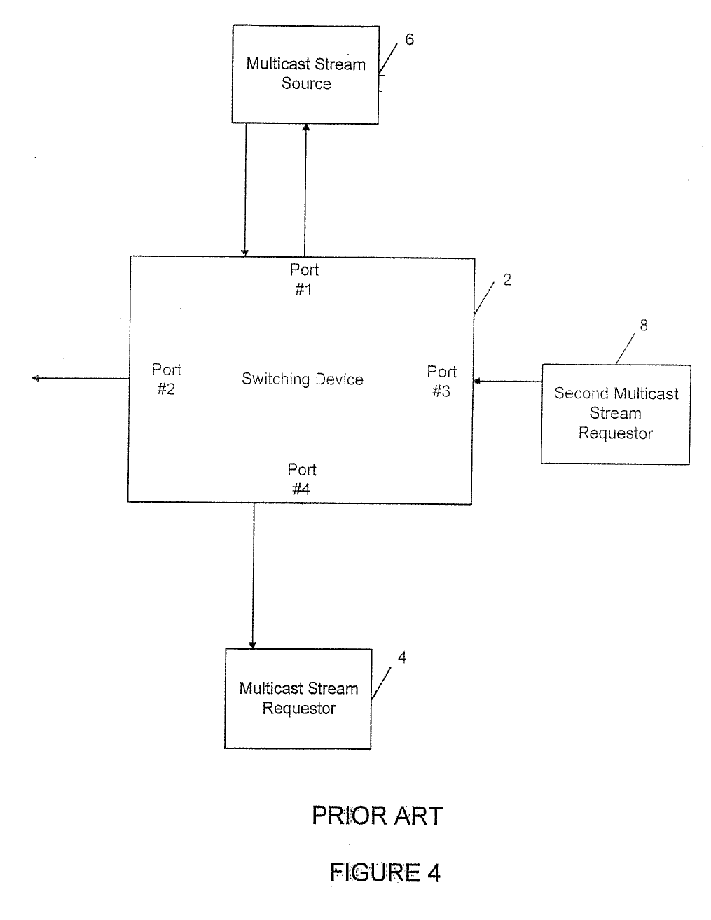

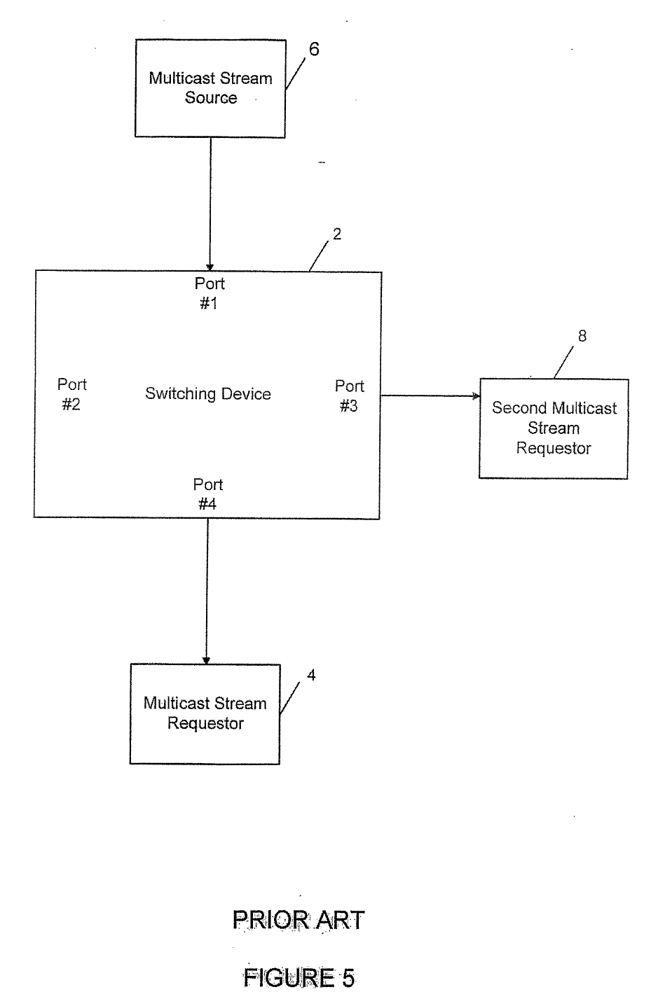

As noted above, FIGS. 1-5 illustrate a conventional or prior art system utilizing IGMP protocol with an unreliable link. The present invention implements a distributed IGMP implementation utilizing a reliable link. It connects to one or more multicast data sources from one node within a collection of cooperating computing devices. Other computing devices within the collection of cooperating computing devices connect to one or more IP hosts who wish to receive the multicast data. All computing devices run autonomously and are geographically dispersed. By geographically dispersing the computing devices, overhead is reduced which means more efficient use of the computing device and more efficient use of the bandwidth. Dispersed CPUs collect information about what multicast traffic individual end users (consumers or multicast stream requesters) are interested in and then coordinate with a central processor module that will request these services from the multicast source.

The IGMP implementation is divided between the computing device that connects to the multicast data sources and the computing devices that connect consumers to that source. The IGMP process, in essence, is subdivided into two separate functions: the function that connects to the multicast sources, and the function that connects to the multicast consumers. These functions run on separate computing devices that are connected via a reliable link in order to coordinate multicast data stream forwarding.

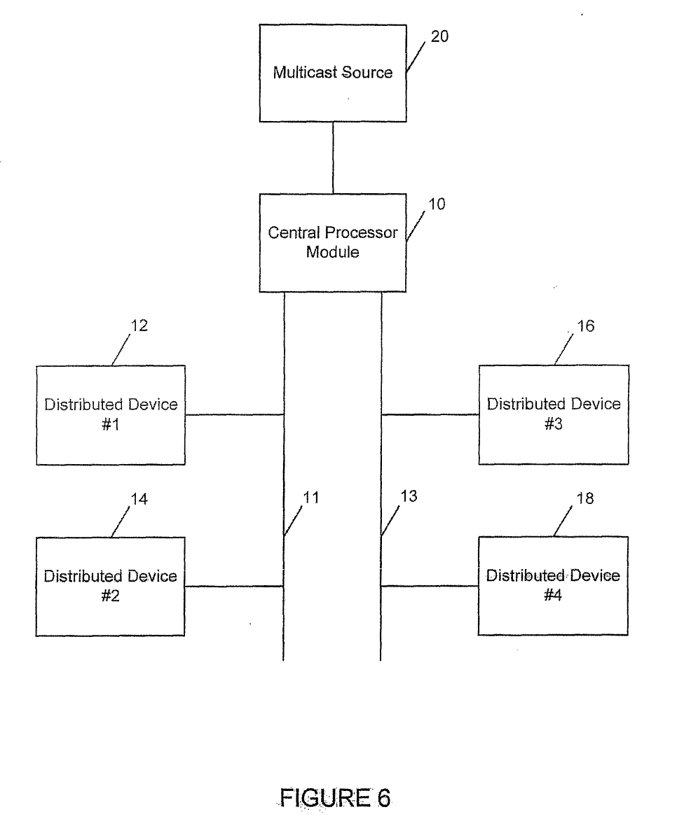

FIG. 6 illustrates an exemplary embodiment of the system of the present invention. The exemplary embodiment is illustrated by a central processing module 10 connected to four (4) distributed devices 12, 14, 16, 18 and a multicast source 20. Distributed devices #1 and #2 12, 14 (which are used to communicate with the consumers) are connected to the central processor module 10 via a first transmission line 11 while distributed devices #3 and #4 16, 18 are connected to the central processor module 10 via a second transmission line 13. The distributed devices 12, 14, 16, 18 transmit requests over transmission lines 11, 13 to the multicast source via the central processing module 10. The central processor module 10 provides multicast streams utilizing layer 2 ports. Although four (4) distributed devices are illustrated, those skilled in the art will recognize that additional (or fewer) distributed devices may be utilized.

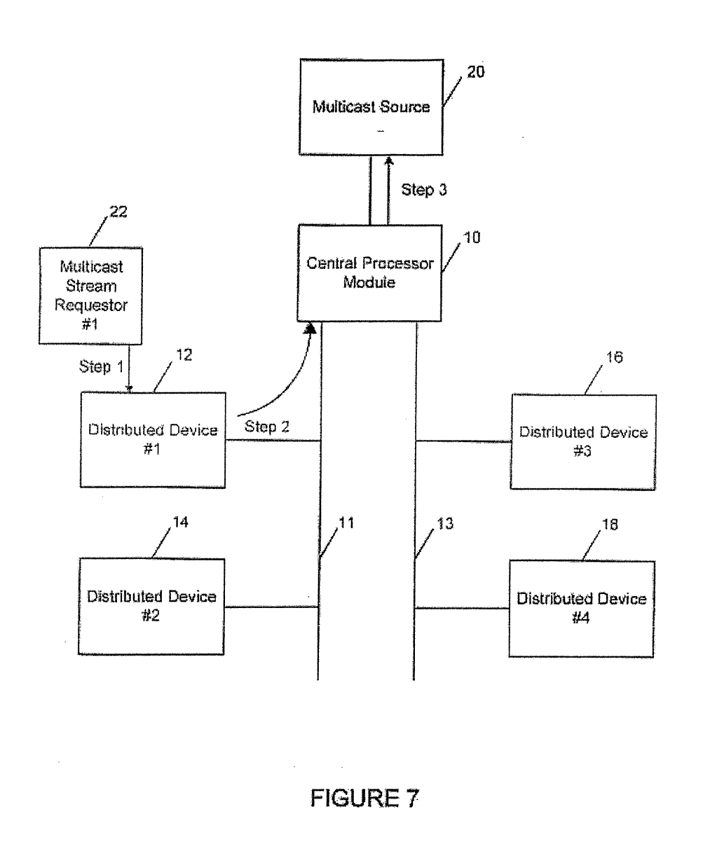

Turning to FIG. 7, a multicast stream requestor #1 22 is added to the system. Requesting a multicast stream is a three-step process. In the first step, the multicast stream requestor #1 22 issues an IGMP membership report request for a multicast stream through distributed device #1 12. Once the distributed device #1 12 recognizes that it has no other attached multicast stream requesters for the multicast stream that have requested an IGMP membership report request, the distributed device #1 12 sends a multicast stream update request to the central processor module 10 via a reliable link over the first transmission line completing step 2. The central processor module 10 recognizes it has no other attached distributed devices using the multicast stream, so the central processor module 10 sends an IGMP membership report request to the multicast source 20 completing the third step. As distributed devices #1-#3 do not have a multicast stream requester, they do not issue an IGMP membership report request.

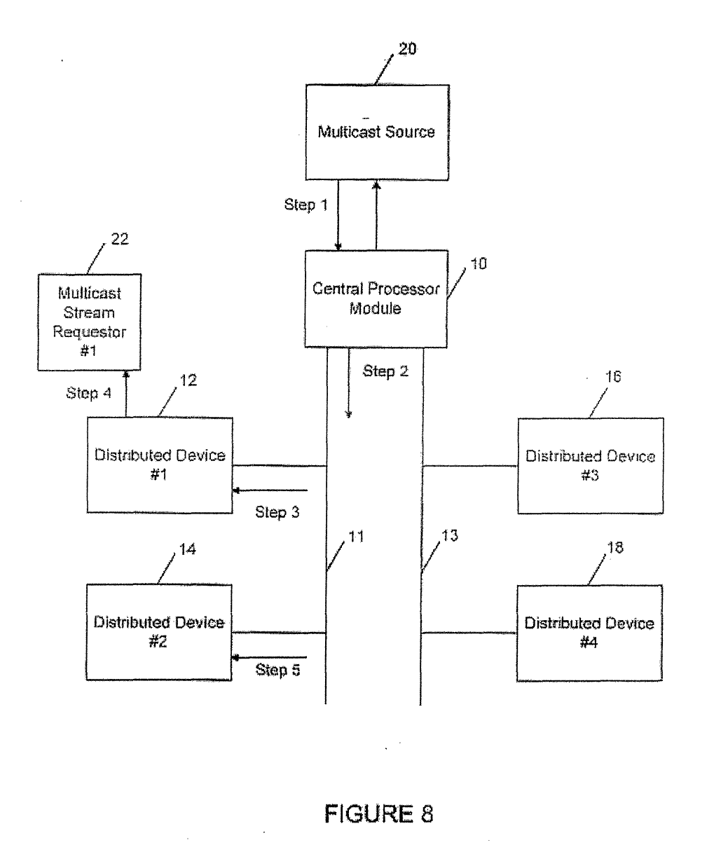

FIG. 8 illustrates the system of the present invention after the multicast source 20 has received the IGMP membership report request. Receiving a multicast stream is a five-step process. In the first step, upon receipt of the IGMP membership report request, the multicast source 20 transmits the multicast stream to the central processor module 10. The central processor module 10 then forwards the multicast stream, only via the first transmission line 11, for which a distributed device had previously requested it completing step 2.

Next, as distributed device #1 12 requested the multicast stream, distributed device #1 12 receives and accepts the multicast stream completing step 3. After accepting the multicast stream, distributed device #1 forwards the multicast stream to the multicast stream requester #1 22 completing step 4. Finally, in step 5, since the distributed device #2 is also connected to the first transmission line 11, the distributed device #2 also receives the multicast stream. However, since the distributed device #2 does not have an attached multicast stream requestor that has requested the stream via an IGMP membership report request, the distributed device #2 discards all packets on that stream. If a multicast stream requester requests a multicast stream through distributed device #3 16 or distributed device #4 18, the request would be sent to the central processor module via transmission line 13 via a reliable link.

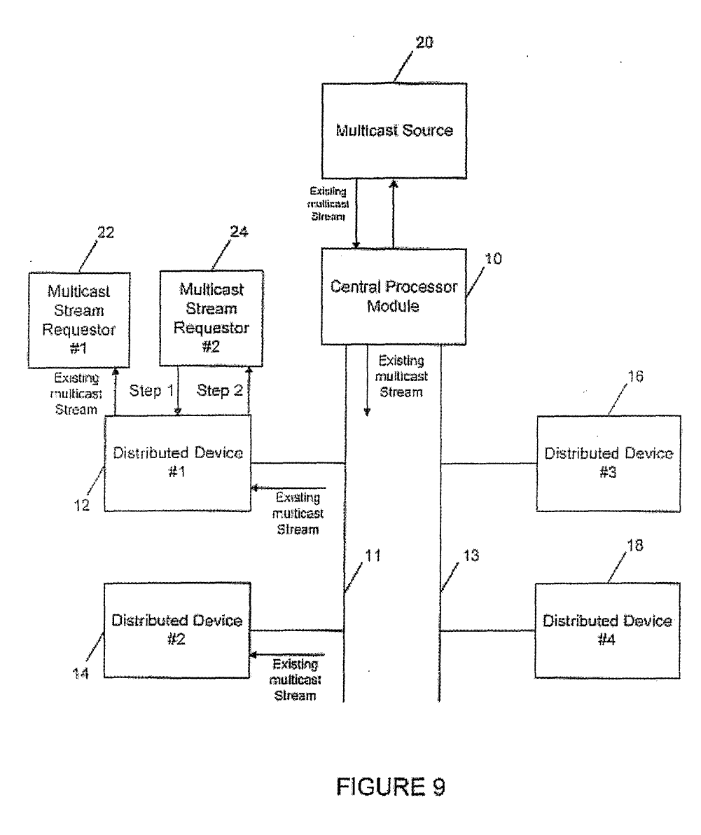

FIG. 9 illustrates the system of the present invention with multiple multicast stream requesters. The addition of another multiple stream requestor requesting a multicast stream is a two-step process. In FIG. 9, a second multicast stream requester, multicast stream requester #2 24 issues an IGMP membership report request, completing step 1, in order to receive the multicast stream. Since the distributed device #1 already has a multicast stream requester (#1) 22 receiving the existing stream, distributed device #1 12 does not forward the request. Instead, the existing multicast stream is simply forwarded to multicast stream requestor #2 24 as well as to multicast stream requestor #1, completing step 2. In prior art systems, there is no reliable link and no designated central processor module. As such, the distributed device #1 12 would have to send an IGMP membership report request to the central processor module 10 periodically. As a result, both the overall bandwidth and the processing load on the central processor module are reduced which optimizes the system that is being shared by a large number of users.

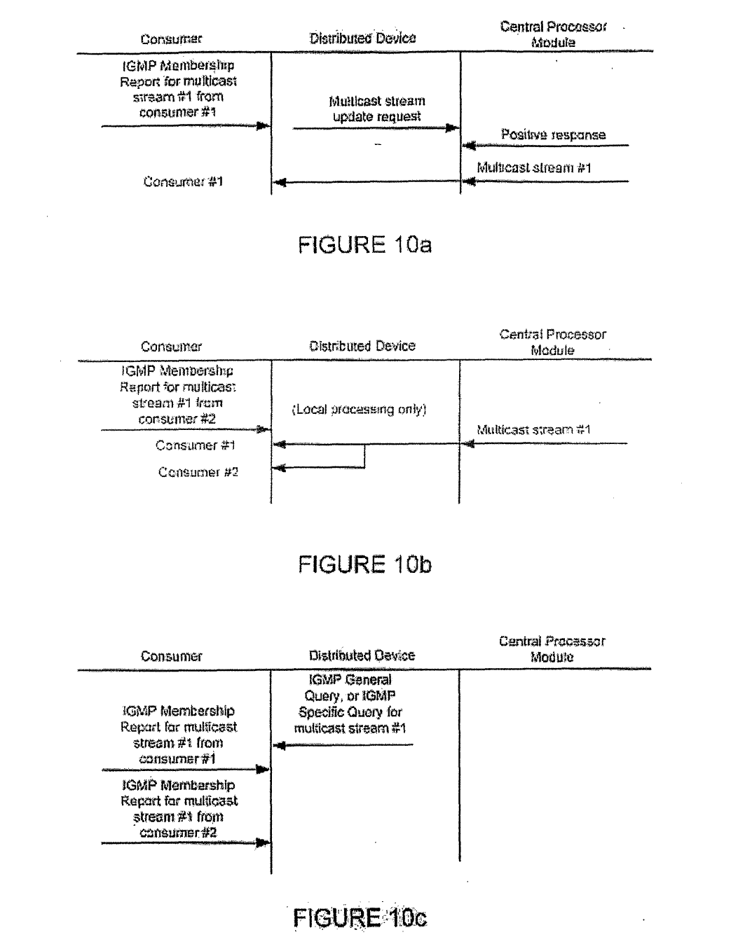

FIGS. 10a-b illustrate flow diagrams of a first example of an implementation of the present invention at the ONU near an end user (consumer or multicast stream requester). As illustrated in FIG. 10a, a first consumer, attached to a distributed device, requests multicast stream #1. Upon initiating a request, an IGMP membership report for multicast stream #1 from the first consumer is sent to the distributed device. When the distributed device receives the request, a multicast stream update request is sent to the central processor module. The central processor module acknowledges the request by sending a positive response to the distributed device. Following this action, the central processor module sends the multicast stream #1 to the distributed device, which in turn sends it to the first consumer.

FIG. 10b illustrates a flow diagram of a second consumer attached to the distributed device requesting the multicast stream #1. Upon initiating the request, an IGMP membership report for multicast stream #1 from the second consumer is sent to the distributed device. When the distributed device receives the request, the distributed device recognizes that multicast stream #1 is currently being sent by the central processor module, so the distributed device performs only local processing and does not sent a request to the central processor module. As a result, both the overall bandwidth and the processing load on the central processor module are reduced which optimizes the system that is being shared by a large number of users.

FIG. 10c illustrates a flow diagram of the distributed device maintaining the IGMP protocol to consumers. In maintaining the IGMP protocol, IGMP membership report requests multicast stream #1 from both the first and second consumers is sent to the distributed device. The distributed device also periodically issues an IGMP general query or an IGMP specific query for the multicast stream #1 to ensure that both consumers are still receiving the multicast stream #1. By processing the IGMP membership report requests and IGMP queries locally at the distributed device, all periodic IGMP requests that simply confirm existing multicast stream requestor requirements do not have to be sent to and from the central processor module for each consumer and as a result, both the overall bandwidth and the processing load on the central processor module are reduced which optimizes the system that is being shared by a large number of users.

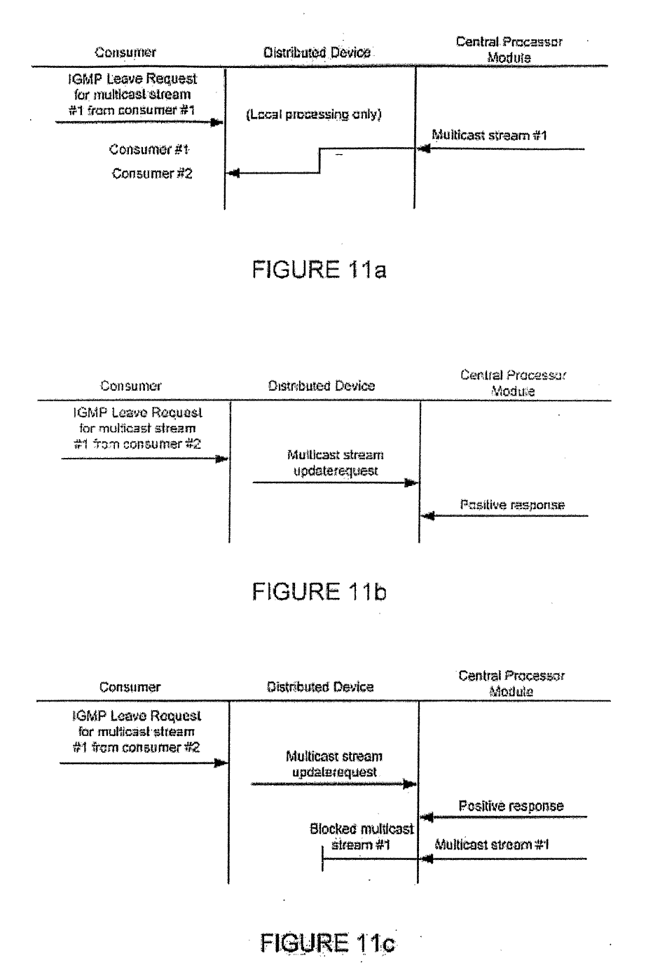

FIGS. 11a-c illustrate flow diagrams of a second example of an implementation of the present invention at the distributed device near an end user (consumer or multicast stream requester). As illustrated in FIG. 11a, the first consumer, attached to the distributed device, no longer requires the multicast stream #1 and sends a request to discontinue receiving multicast stream #1. Upon initiating the request, an IGMP leave request for multicast stream #1 from the first consumer is sent to the distributed device. When the distributed device receives the request, the distributed device recognizes that multicast stream #1 is currently being sent by the central processor module to the first and second consumer, so the distributed device performs only local processing and does not send a multicast stream update request to the central processor module. From the local processing, the distributed device recognizes that the multicast stream #1 should be discontinued to the first consumer and continued to the second consumer. As a result, both the overall bandwidth and the processing load on the central processor module are reduced which optimizes the system that is being shared by a large number of users.

FIG. 11b illustrates a flow diagram of a second consumer, attached to the distributed device, requesting to no longer receive the multicast stream #1. Upon initiating the request, an IGMP leave request for multicast stream #1 from the second consumer is sent to the distributed device. When the distributed device receives the request, a multicast stream update request is sent to the central processor module, as no other distributed devices require the central processor module to continue the multicast stream #1. The central processor module acknowledges the request by sending a positive response and the multicast stream #1 is no longer sent to the distributed device.

FIG. 11c illustrates a flow diagram of a second consumer, attached to the distributed device, requesting to no longer receive the multicast stream #1, however other distributed devices still require the central processor module to continue sending the multicast stream #1. Upon initiating the request, an IGMP leave request for multicast stream #1 from the second consumer is sent to the distributed device. When the distributed device receives the request, a multicast stream update request is sent to the central processor module. The central processor module acknowledges the request by sending a positive response. The multicast stream #1 continues to be received by the distributed device as other distributed devices continue to receive the multicast stream, however, the multicast stream #1 is blocked as to the second consumer so the second consumer no longer receives the multicast stream #1.

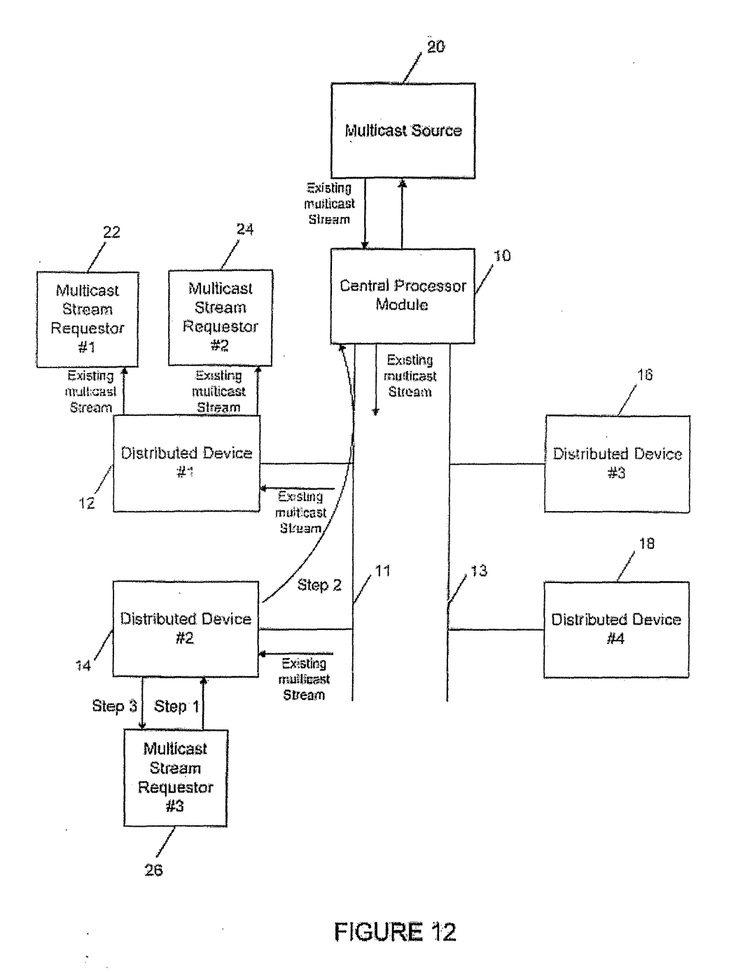

FIG. 12 illustrates the system of the present invention with multiple multicast stream requesters connected to multiple distributed devices. Receiving an IGMP membership report request from multiple distributed devices when at least one distributed device on the same link already receives the multicast stream is a three-step process. FIG. 9 illustrates how multicast stream requestor #1 22 and multicast stream requestor #2 24 initiate reception of the multicast stream. However, a third multicast stream requester #3 26 is connected to the system via distributed device #2 14.

In addition to the multicast stream requesters #1 and #2, 22 and 24 respectively, the third multicast stream requester #3 26 issues an IGMP membership report request in order to receive the multicast stream completing step 1. The third multicast stream requester #3 26 is connected to the distributed device #2 14 which recognizes that is has no other attached multicast stream requesters for the multicast stream and thus, is not receiving the existing multicast stream. As such, the distributed device #2 sends a multicast stream update request to the central processor module 10 via a reliable link over the first transmission line 11 and receives the existing multicast stream completing step 2. Since the central processor module 10 recognizes that it is already forwarding the multicast stream onto transmission line 11, no other action is required on its part. The central processor module 10 simply notes that a second distributed device #2 14 concurrently requires the multicast stream. In addition, since the multicast stream is already being forwarded onto the transmission line 11 by the central processor module, the distributed device #2 14 ceases blocking the multicast stream and instead forwards the multicast stream to the multicast stream requestor #3.

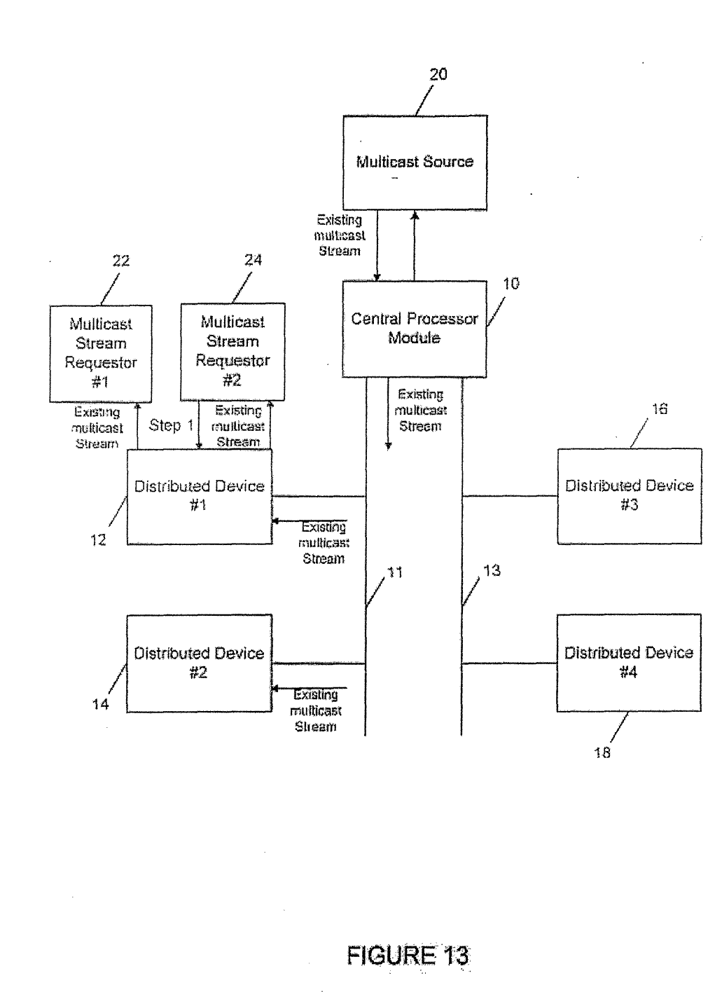

FIG. 13 illustrates the advantage of the present invention in utilizing a reliable link. As described in FIG. 6, a central processing module 10 is connected to four (4) distributed devices 12, 14, 16, 18 and a multicast source 20. Distributed devices #1 and #2 12, 14 are connected to the central processor module 10 via a first transmission line 11 while distributed devices #3 and #4 16, 18 are connected to the central processor module 10 via a second transmission line 13. The distributed devices 12, 14, 16, 18 transmit requests to the multicast source 20 via the central processing module 10. In addition to the central processing module 10, four distributed devices 12, 14, 16, 18 and a multicast source 20, FIG. 13 also contains multicast stream requestors 22 and 24. This figure illustrates that from time to time, one or another of the multicast stream requesters issue an IGMP membership report request. The distributed device to which the multicast stream requesters are attached do not forward an indication of this IGMP membership report request to the central processor module since the distributed device has done so previously over a reliable link and so does not need to repeat the request to the central processor module 10.

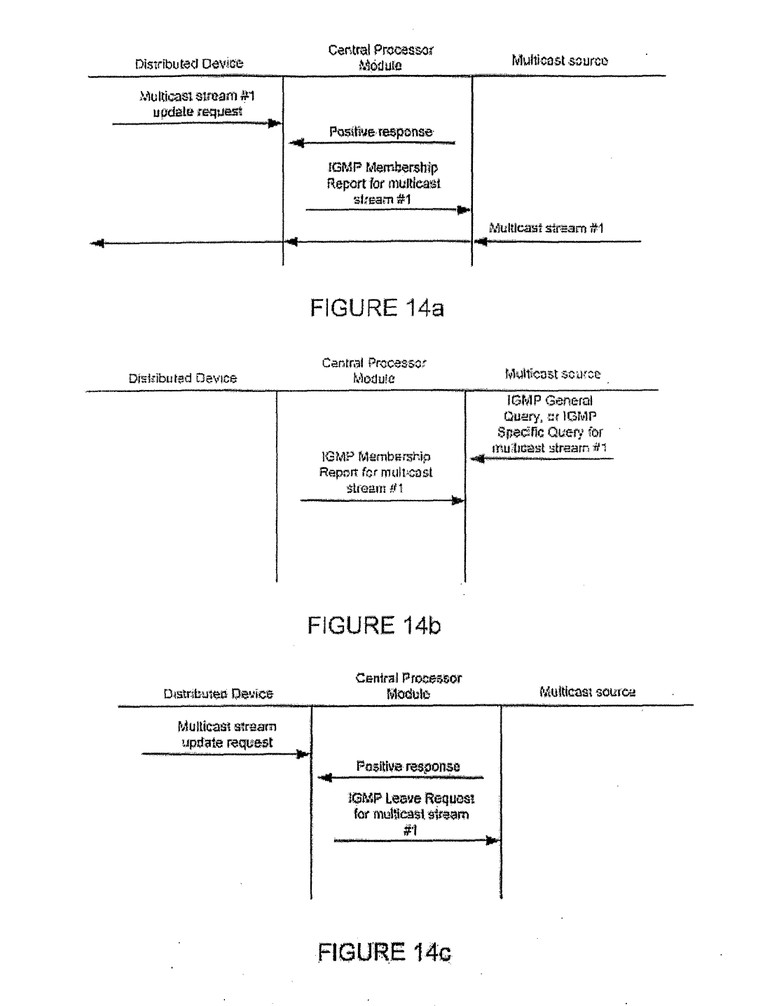

FIGS. 14a-b illustrate flow diagrams of the central processor module role in an exemplary embodiment of the present invention. As illustrated in FIG. 14a, the central processor module receives a multicast stream #1 update request from the distributed device that requests a multicast stream. Upon receiving the request, the central processor module sends a positive response to the distributed device. In addition, an IGMP membership report for the multicast stream #1 is transmitted to the multicast source. Once the multicast stream #1 is sent from the multicast source to the central processor module, the central processor module subsequently sends it to the distributed device.

FIG. 14b illustrates a flow diagram of the central processor module maintaining IGMP protocol with the multicast source. To maintain the IGMP protocol, the multicast source, sends an IGMP general query or an IGMP specific query for the multicast stream #1 to the central processor module. In response to this, the central processor module sends an IGMP membership report for the multicast stream #1 to the multicast source. In addition, the central processor module may periodically send an unsolicited IGMP membership report to the multicast source to ensure that the IGMP protocol is maintained.

FIG. 14c illustrates a flow diagram when the distributed device indicates multicast stream #1 is no longer needed, and no other attached distributed devices currently requires multicast stream #1. The distributed device sends a multicast stream update request indicating that the multicast stream #1 is no longer needed. Upon receipt of the request, the central processor module sends an IGMP leave request for multicast stream #1 to discontinue multicast stream #1 and a positive response is sent from the central processor module to the distributed device. The multicast source may choose to continue sending the multicast stream #1 or it may choose to discontinue sending the multicast stream #1. If the multicast source continues to send the stream, the central processor module will not forward the stream to the distributed device, thus, both the overall bandwidth and the processing load on the central processor module are reduced which optimizes the system that is being shared by a large number of users.

In an alternative embodiment, the present invention could be generalized to allow one or more nodes to implement both the multicast sources support function and the multicast consumers support function. Under such a generalization, a computing device could connect to one or more multicast sources, and could support multicast consumers connected to other computing devices, while at the same time supporting multicast consumers that utilize the multicast source support function via any other computing device within the collection of cooperating computing devices. Additionally, the protocol at the central processor module can be any multicast routing protocol, including but not limited to PIM, SMRP, MOSPF and IGMP and the system can include, but it not limited to a passive optical network.

Although an exemplary embodiment of the invention has been described above by way of example only, it will be understood by those skilled in the field that modifications may be made to the disclosed embodiment without departing from the scope of the invention, which is defined by the appended claims.

We claim:

1. A method of distributing multicast stream forwarding requirements as defined by the IGMP protocol over a reliable link within a system of multiple devices where an existing multicast stream is accessed via a specific set of layer 2 ports connected to a central processor module, the method comprising the steps of:
issuing an IGMP membership report request for the existing multicast stream by a first multicast stream requester;
determining if more than one multicast stream requestor is attached to a first distributed device;
sending a multicast stream request to a first port of the central processor module via a reliable link; and
sending the IGMP membership report request to a multicast source if the central processor module has no other attached distributed devices requesting the existing multicast stream.

2. The method of claim 1, further comprising the steps of:
transmitting the existing multicast stream to the central processor after the multicast source has received the IGMP membership report request; and
forwarding the existing multicast stream through the first port of the central processor module to the first distributed device, wherein the first distributed device accepts the existing multicast stream.

3. The method of claim 2, wherein a second distributed device receives the existing multicast stream and discards all the packets on the existing multicast stream since the second distribute device is not attached to a multicast stream requestor that requested the existing multicast stream via a separate IGMP membership report request.

4. The method of claim 2, further comprising the step of a second multicast stream requestor issuing a second IGMP membership report request to receive the existing multicast stream.

5. The method of claim 4, wherein the first distributed device does not send a multicast stream update request to the central processor module since the first distributed device is receiving the existing multicast stream.

6. The method of claim 5, wherein the existing multicast stream is forwarded to the second multicast stream requester through the first port of the central processor module, since the first distributed device is already receiving the existing multicast stream.

7. The method of claim 6, further comprising the step of a third multicast stream requester issuing a third IGMP membership report request to a second distributed device in order to receive the existing multicast stream.

8. The method of claim 7, further comprising the step of sending a second multicast stream update request to the central processor module.

9. The method of claim 8, wherein the second distributed device immediately forwards the existing multicast stream to the third multicast stream requestor since the multicast stream is already being received by the second distributed device.

10. The method of claim 9, wherein the first distributed device or the second distributed device does not forward a multicast stream update request to the central processor module, since the first distributed device or the second distributed device has previously sent a multicast stream update request over a reliable link and does not need to repeat the request.

11. The method of claim 1, further comprising the step of discontinuing the existing multicast stream by the at least one distributed device by sending a multicast stream update request to the central processor module.

12. A system of utilizing carrying the information required to distribute IGMP protocol functionality over a reliable link with multiple devices where an existing multicast stream is accessed via a specific set of layer 2 ports connected to a central processor module, the system comprising:
a central processor module;
at least one distributed device attached to the central processor module via at least one transmission line; and
at least one multicast stream requester, attached to the at least one distributed device, for requesting an IGMP membership report request.

13. The system of claim 12, further comprising:
a multicast source attached to the central processor module for receiving the IGMP membership report request from the at least one multicast stream requestor.

14. The system of claim 13, wherein the central processor module is comprised of at least one layer 2 port.

15. The system of claim 14, wherein the at least one distributed device sends all multicast stream update requests through the same at least one layer 2 port to the central processor module to receive the existing multicast stream.

16. The system of claim 15, wherein the multicast source sends the existing multicast stream through the same at least one layer 2 port to the central processor module.

17. The system of claim 12, wherein the at least one distributed device recognizes it has no other attached multicast stream requestors for the existing multicast stream, so it send a multicast stream update request to the central processor module via the reliable link.

18. The system of claim 17, wherein the central processor module sends the existing multicast stream to all the at least one distributed devices containing multicast stream requesters that have issued a multicast stream update request.

19. The system of claim 12, wherein the at least one distributed device does not forward the multicast stream update request if a second multicast stream requester of the at least one distributed device has already sent the IGMP membership report update request.

20. The system of claim 19, wherein the existing multicast stream is forwarded to all multicast stream requestors which have issued the IGMP membership report update request.

21. The system of claim 12, wherein the at least one distributed device does not forward the multicast stream update request to the central processor module if the at least one distributed device has already done so over the reliable link.

22. A method of distributing multicast stream forwarding requirements using a multicast protocol over a reliable link within a system of multiple devices where an existing multicast stream is accessed via ports connected to a central processor module, the method comprising the steps of:
issuing a membership report request for the existing multicast stream, by a first multicast stream requester;
determining if more than one multicast stream requester is attached to a first distributed device;
sending a multicast stream request to a first port of the central processor module via a reliable link; and
sending the membership report request to a multicast source if the central processor module has not other attached distributed devices requesting the existing multicast stream.

23. The method of claim 22, wherein the multicast protocol can be selected from a group consisting of PIM, SMRP, MOSPF and IGMP.

24. The method of claim 23, further comprising the steps of:
transmitting the existing stream to the central processor after the multicast source has received the membership report request.

25. The method of claim 23, wherein a second distributed device receives the existing multicast stream and discards all the packets on the existing multicast stream since the second distributed device is not attached to a multicast stream requestor that requested the existing multicast stream via a separate membership join report request.

26. The method of claim 25, wherein the system is a passive optical network.

27. A method of distributing multicast stream forwarding requirements using a multicast protocol over a reliable link within a passive optical network of multiple devices where an existing multicast stream is accessed via ports connected to a central processor module, the method comprising the steps of:
issuing a membership report request for the existing multicast stream, by a first multicast stream requestor;
determining if more than one multicast stream requestor is attached to a first distributed device;
sending a multicast stream request to a first port of the central processor module via a reliable link; and
sending the membership report request to a multicast source if the central processor module has not other attached distributed devices requesting the existing multicast stream.
